(19) United States
(12) Patent Application Publication
(10) Pub. No.: US 2026/0068872 A1
(43) Pub. Date: Mar. 12, 2026

(54) MULTI-PURPOSE STAND

(71) Applicant: 4J OUTDOORS, LLC, Doraville, GA (US)

(72) Inventors: James E. Parchman, JR., Cumming, GA (US); Jeffrey Ray Adkins, Temple, GA (US); Jonathan Ray Adkins, Temple, GA (US); Joseph Allen Rush, Bremen, GA (US)

(21) Appl. No.: 18/830,961

(22) Filed: Sep. 11, 2024

(51) Int. Cl. A01M 31/02

(52) U.S. Cl. CPC A01M 31/02

(57) ABSTRACT

A multi-purpose platform includes an upstanding bracket configured to receive a bearing receiving a post attached to a seat. The platform includes four brackets around its periphery which can be selectively used to attach legs to allow for the differing modes of use. A plate having an arcuate toothed portion is provided to be leaned against a tree or pole with the teeth acting to grip the tree or pole. Opposite the plate are bracket members for attachment of a ladder. Leveling gauges are provided perpendicular to one another so that the user can ensure that the platform is level in two degrees of freedom when it is being installed in its location of proposed use.

### BACKGROUND OF THE INVENTION

The present invention relates to a multi-purpose stand. In the prior art, stands of various types are well known. As examples, tree stands lean against a tree or pole and have a ladder attached to a platform where a hunter may sit on a chair or seat provided for that purpose. Other possible examples are tripods that are freestanding as well as stands having two or four legs and a ladder.

Such varieties of stands although well known are limited in that each particular type of stand may only be provided for a singular purpose. A need has developed for a stand device which may be re-configured into multiple modes of use as desired and to fulfill differing purposes and situations. It is with this need in mind that the present invention was developed.

### SUMMARY OF THE INVENTION

The present invention relates to a multi-purpose stand. The present invention includes the following details, embodiments, aspects, and features:
(1) The heart of the present invention is a multi-purpose platform that enables the use of the present invention in multiple modes of use. The platform includes an upstanding bracket which is designed to receive a commercial grade bearing that receives a post attached to a seat.
(2) The platform includes four brackets around its periphery which can be selectively used to attach legs which may be sectional in nature to allow for the differing elevations and modes of use.
(3) An arcuate plate with teeth formed thereon is provided to be leaned against a tree or pole with the teeth acting to grip the tree or pole when the platform is being configured for use as a tree stand with a ladder opposite the plate bearing the teeth.
(4) At least two leveling gauges are provided perpendicular to one another so that the user can ensure that the platform is level in two degrees of freedom when it is being installed in its location of proposed use.
(5) Where the inventive device is being used with legs in addition to a ladder, each leg has an extendable foot which may be adjusted to ensure that all the legs are engaged with a ground surface particularly under circumstances in which the ground surface is uneven. In the preferred embodiment, each leg has multiple sections which may be bolted together for strong interconnection so that the inventive stand is safe for a user to climb and use.
(6) In the preferred embodiment, the present invention is made of a strong steel or aluminum that is durable and rustproof and may easily be assembled for use and disassembled for storage.

Accordingly, it is a first object of the present invention to provide a multi-purpose stand.

It is a further object of the present invention to provide such a stand in which a versatile platform is employed that facilitates multiple modes of use.

It is a yet further object of the present invention to provide such a stand which may be used as a tree stand having a portion gripping a tree or pole and with a single ladder support.

It is a still further object of the present invention to provide such a stand in which two or four additional legs may be employed for additional stability and to facilitate using the stand in a freestanding configuration.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a top view of the inventive platform of the inventive stand.

FIG. 2 shows a view similar to that of FIG. 1 but also showing the chair bracket mounted on top of the platform.

FIG. 3 shows a side view of the platform.

FIG. 4 shows a bottom view of the platform.

FIG. 5 shows a further bottom view showing the platform with four support legs and a ladder attached thereto.

FIG. 6a shows a closeup side view of the bracket mounted on the platform with a chair mounted thereto, and FIG. 6b shows a side view of a portion of the bracket showing details of the upper and lower commercial bearings.

FIG. 7 shows a further view of the bracket and chair showing the details of a chair post and a commercial bearing mounted on the bracket.

FIG. 8 shows a side view of the inventive stand used solely supported against a pole with a single ladder attached thereto.

FIG. 9 shows a further perspective view of the stand configuration of FIG. 8.

FIG. 10 shows a yet further perspective view of the stand of FIG. 8.

FIG. 11 shows a perspective view of the inventive stand in which the platform is supported by a ladder and two legs.

FIG. 12 shows a further perspective view of the stand configuration of FIG. 11.

FIG. 13 shows a further perspective view of the stand configuration illustrated in FIG. 11.

FIG. 14 shows a yet further perspective view showing the stand configuration of FIG. 11 with a ladder and two legs supporting the platform.

FIG. 15 shows a further configuration of the stand in which the platform is supported by four legs and a ladder.

FIG. 16 shows a further perspective view of the stand configuration of FIG. 15.

FIG. 17 shows a further perspective view of the stand of FIG. 15.

FIG. 18 shows a detail of the bottom of a typical leg of the inventive stand showing the leveling structure.

FIG. 19 shows a further view of the leveling structure of FIG. 18.

FIG. 20 shows a still further view of the leveling structure of the leg of FIG. 18.

FIG. 21 shows an exploded side view of one of the multi-sectional legs showing the structure of a post received within a recess to strengthen the interconnection between sections.

FIG. 22 shows a perspective view showing further details of the connection structure of FIG. 21.

FIG. 23 shows a yet further perspective view showing the interconnection of two sections of a leg as shown in FIGS. 21 and 22.

### SPECIFIC DESCRIPTION OF THE PREFERRED EMBODIMENTS

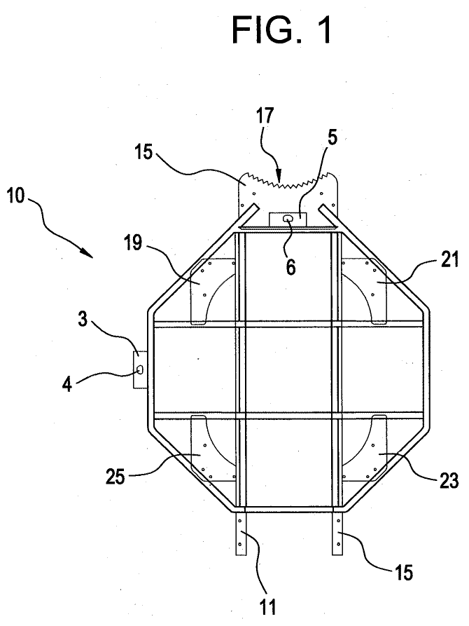

Reference is first made to FIGS. 1-7. Therein, it is seen that the platform 10 takes on an octagonal shape and is made of a mesh material to facilitate drainage of rainwater and to make it lighter in weight. At one side of the platform 10, brackets 11 and 13 are provided to facilitate attachment of a ladder. Diametrically opposite the brackets 11 and 13 is a plate 15 having an arcuate toothed surface 17. Also seen in FIG. 1 are two level indicators 3 and 5 each of which displays a bubble 4 and 6 respectively. These level indicators are orthogonal to one another and are provided to determine whether the platform 10 is level in two degrees of freedom once legs and a ladder are attached thereto in the disclosed embodiments of the present invention.

The arcuate configuration of the teeth 17 is specifically devised to facilitate gripping a circular cross-section tree or pole in one embodiment of the present invention.

Additional brackets 19, 21, 23 and 25 are provided spaced circumferentially about the platform 10. These brackets are provided to facilitate firm attachment of from two to four legs in other embodiments of the present invention. The brackets 19 and 21 are to either side of plate 15. The brackets 23 and 25 are inward of brackets 13 and 11, respectively.

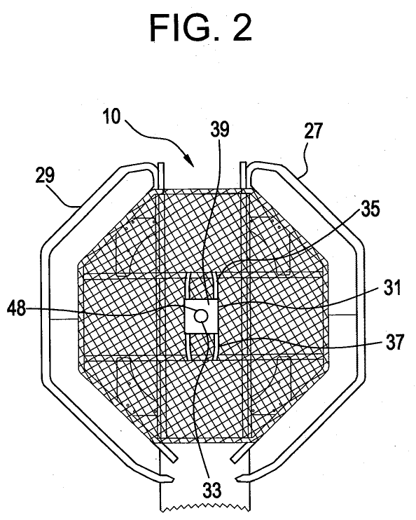

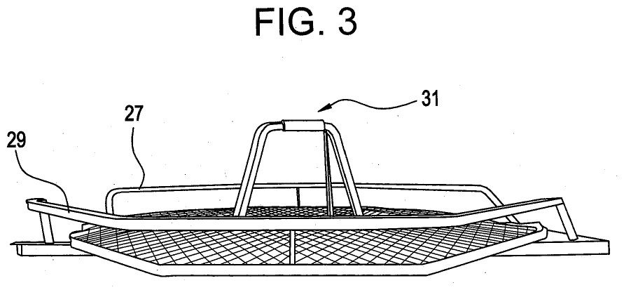

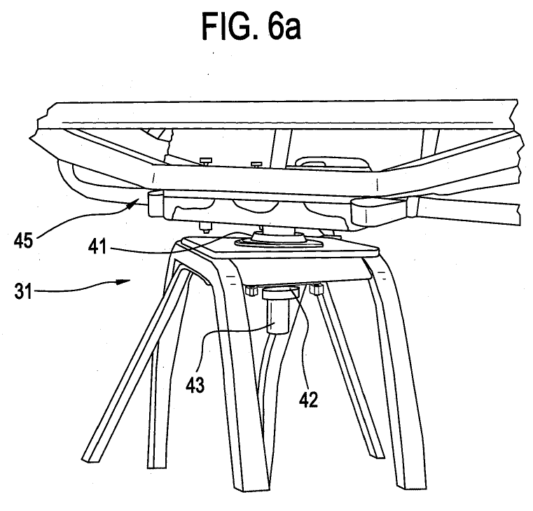

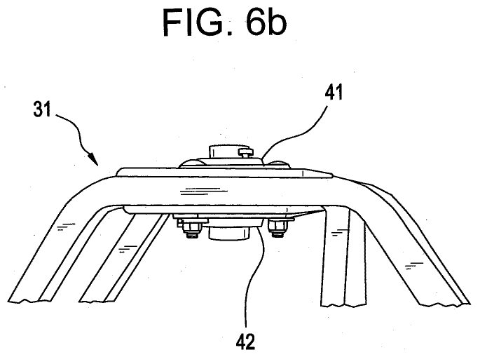

With reference to FIGS. 2 and 3, the platform 10 includes two opposed railings 27 and 29 which are provided for safety so that a person who is on the platform 10 elevated above the ground is less likely to fall off the platform and become injured. In the middle of the platform 10, a bracket 31 is provided which includes a central hole 33 designed to receive a post 43 attached to a seat 45 (FIGS. 6 and 7).

The details of the bracket 31 are better seen in FIGS. 6a, 6b and 7. In particular, with reference to FIG. 7, it is seen that an upper commercial bearing 41 is mounted in the hole 33 and supports a shaft or post 43. The bearing 41 is suitably bolted in place by a plate 47 which includes fasteners 49 which enter the holes 48 which are seen in FIG. 2. As best seen in FIG. 6b there is also a lower commercial bearing 42. The bearings 41 and 42 are an important and essential feature of the present invention. They must be of commercial level quality because they need to facilitate the seat 45 being supported by the post or shaft 43 extending through the bearings 41 and 42 which permit the shaft 43 to rotate within the bearings 41 and 42 without any squeaking or other noises which could alert animals that a hunter is sitting in the seat 45, where the inventive stand is being used for hunting purposes.

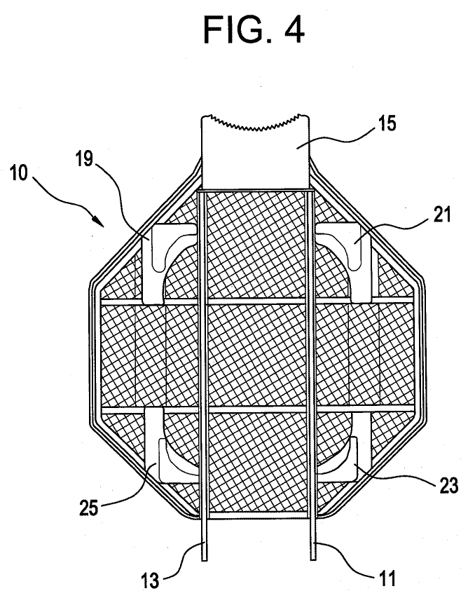

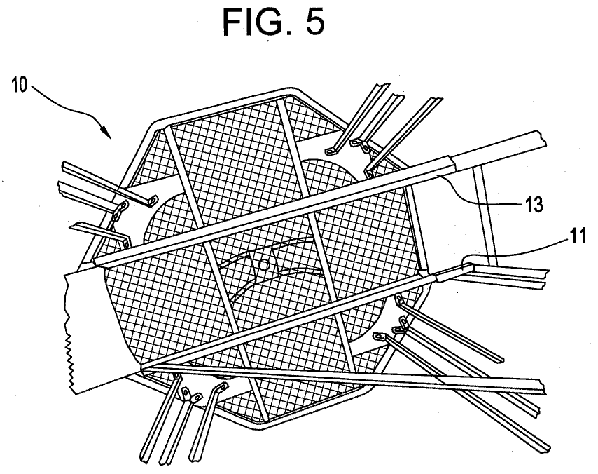

FIGS. 4 and 5 show the platform 10 from below and facilitate showing more details of the platform 10 from its underside. With particular reference to FIG. 4, the brackets 19, 21, 23 and 25 are clearly shown as is the plate 15 with its arcuate teeth 17. Also seen are the brackets 11 and 13 which are used to fasten a ladder to the platform 10. With reference to FIG. 5, the brackets 19, 21, 23 and 25 have legs fastened thereto which will be described in greater detail hereinafter.

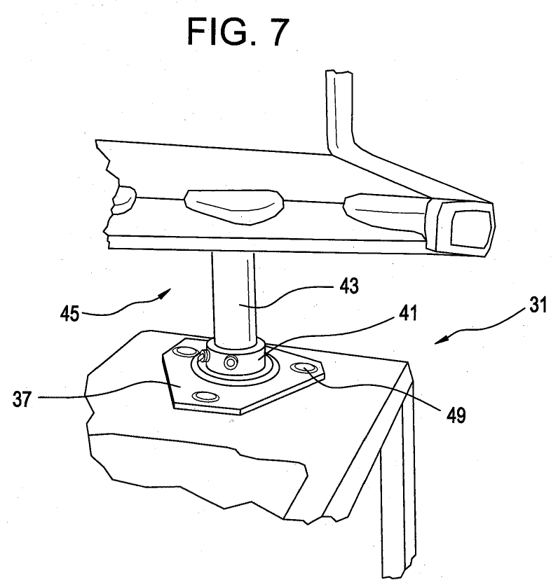

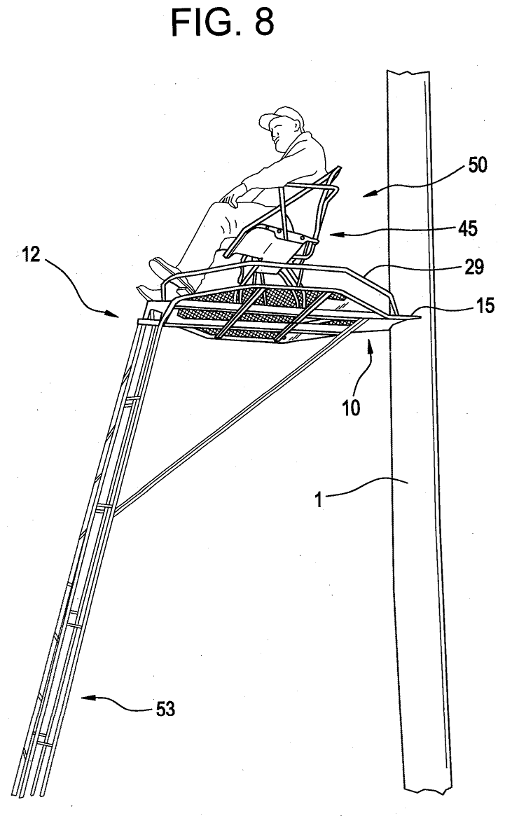

Reference is now made to FIGS. 8-10 which show a first embodiment 12 of the present invention. With reference to FIGS. 8-10, a tree stand is generally designated by the reference numeral 12 and is seen to include the platform 10 as well as the ladder 53 and is leaned against a pole 1 with the teeth 17 of the plate 15 digging into the pole.

The seat 45 is suitably attached with its post extending through the bearing 41 so that the seat can rotate as desired. The railings 27 and 29 are also shown.

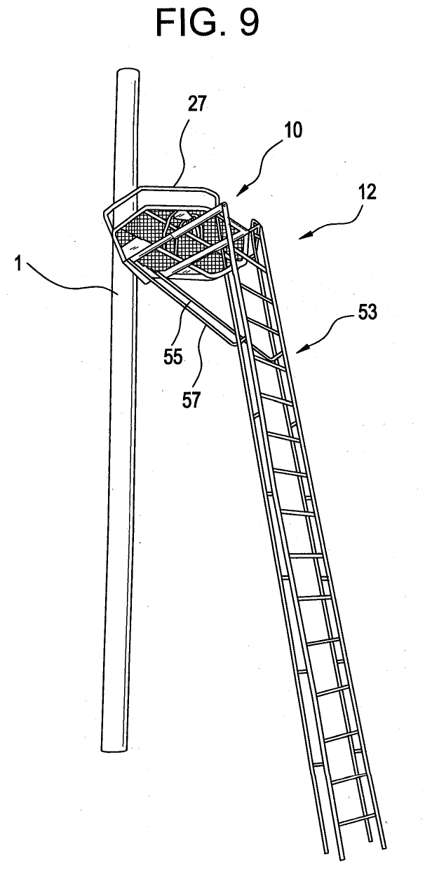

With particular reference to FIG. 10, two braces 55 and 57 are fastened between the platform 10 and the ladder 53 to stabilize the interconnection between the platform 10 and the ladder 53. The ladder 53 as shown is fastened to the brackets 11 and 13.

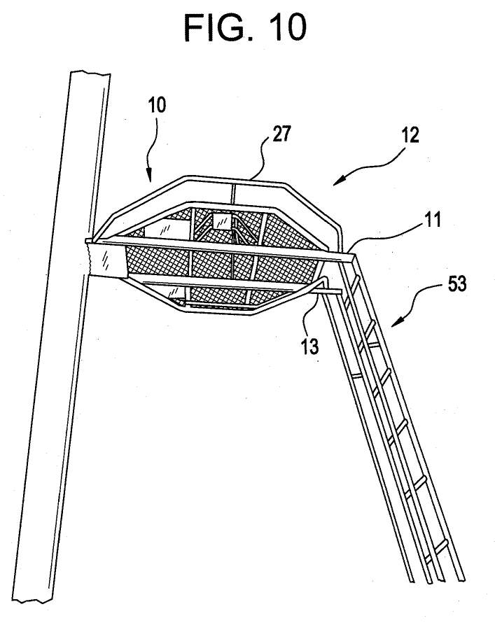

Reference is now made to FIGS. 11-14 which show a second embodiment 14 of the present invention in which the platform 10 is supported by a ladder and two legs. With reference to these figures, it is seen that in addition to the platform 10 and the ladder 53, legs 61 and 63 are provided. These legs are diametrically opposite to the ladder 53. The two brackets 55 and 57 are also visible in these figures and, additionally, a plurality of shafts 65, 67, 69, 71, 73, 75, 77, 79 and 81 are also shown with particular reference to FIG. 11 which are provided to make the inventive stand 14 rigid and safe for a user.

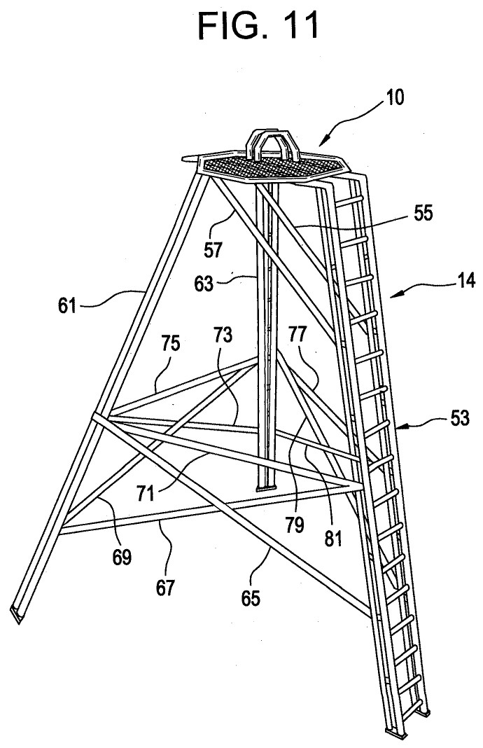

FIG. 12 shows another configuration 14′and also shows the platform 10, the ladder 53, the brackets 55 and 57, and the legs 61 and 63. Shafts 83, 85 and 87 are shown in FIG. 12. The shaft 83 is connected between the ladder 53 and the leg 61. The shaft 85 is connected between the ladder 53 and the leg 63. The shaft 87 is connected between the legs 61 and 63. As shown in FIG. 12, the shaft 87 is shorter than the shafts 83 and 85 due to the configuration of the ladder 53 and the legs 61 and 63.

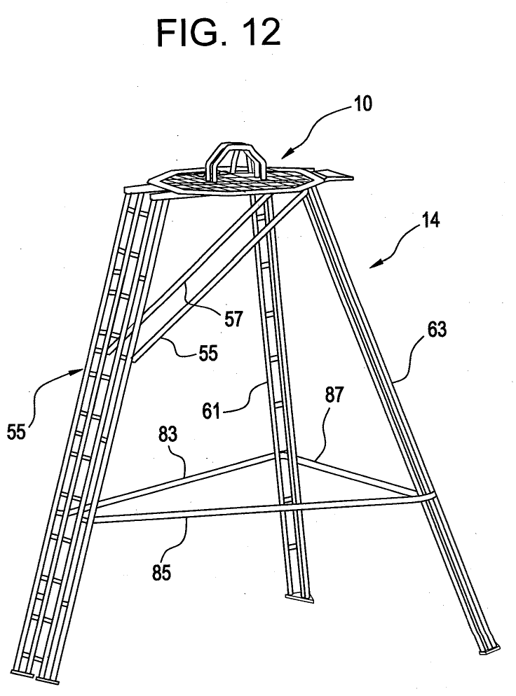

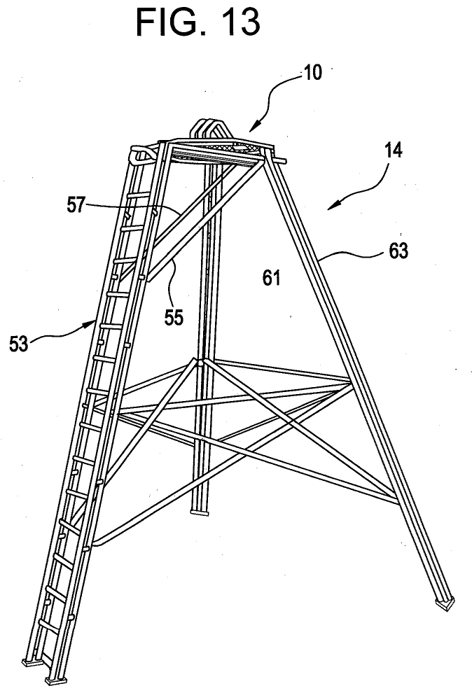

FIG. 13 is similar to FIG. 11 but showing a differing orientation. FIG. 14 is similar to FIG. 12 but showing a differing orientation of the stand 14′. As clear from FIGS. 11-14, the inventive stand may be freestanding when the legs 61 and 63 are provided along with the ladder 53.

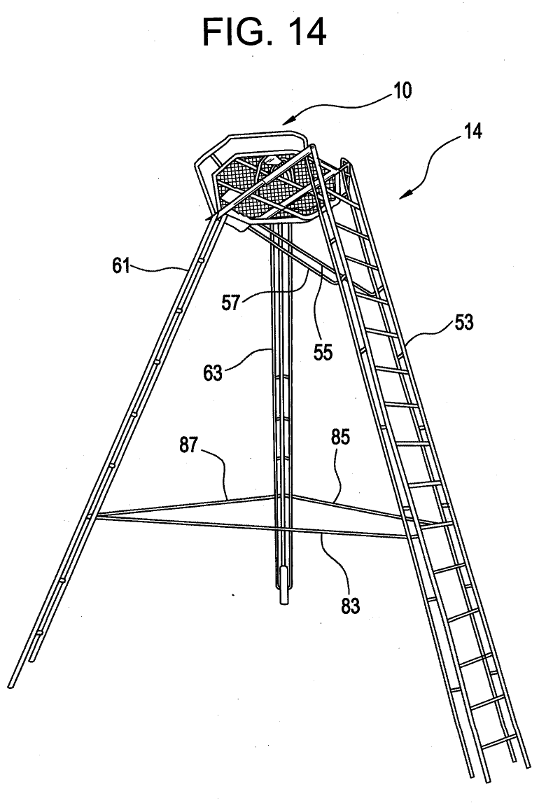

With reference now to FIGS. 15-17, a further embodiment 16 of the present invention is seen to include the platform 10 and the ladder 53 as well as legs 91, 92, 93 and 94 as well as shafts 95, 96, 97 and 98 to render the stand rigid and safe.

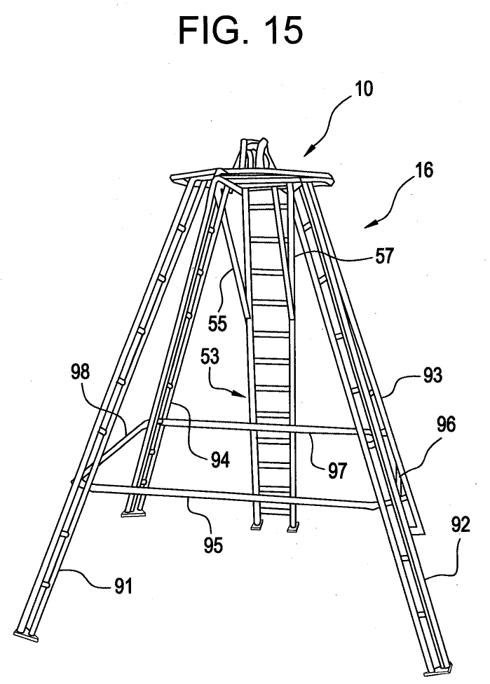

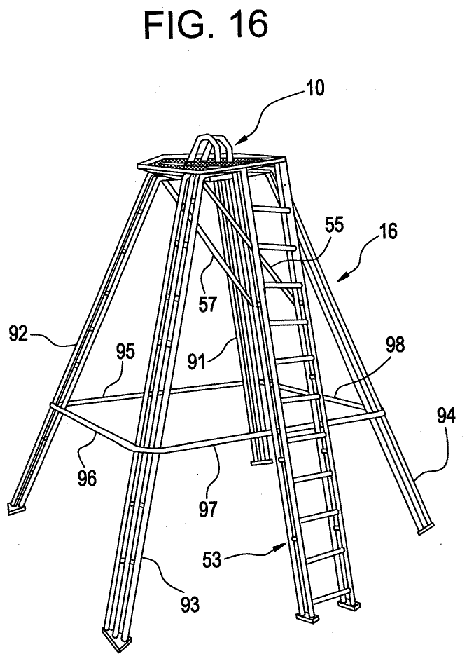

FIG. 17 shows a variation 16′ in which the shafts are located close to the bottom of the legs which provide similar stability to the configuration shown in FIGS. 15 and 16. As seen, the shafts in FIG. 17 are designated by the reference numerals 101, 102, 103 and 104.

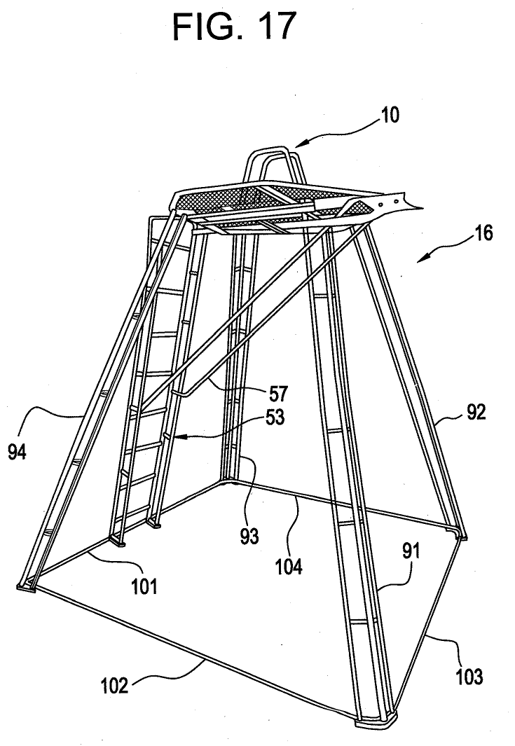

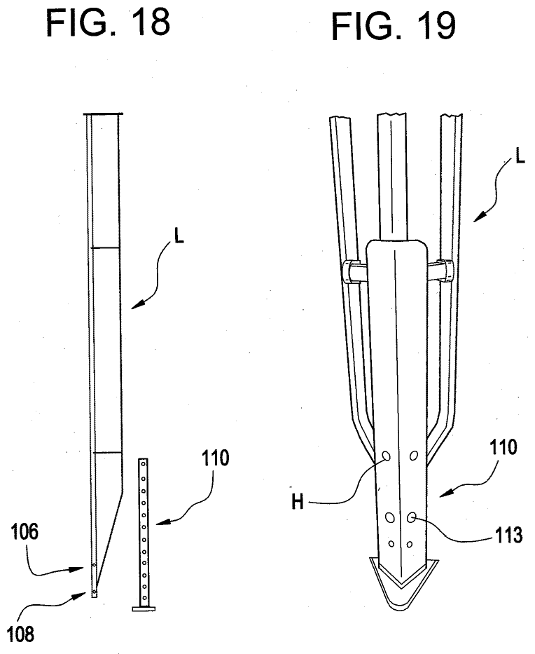

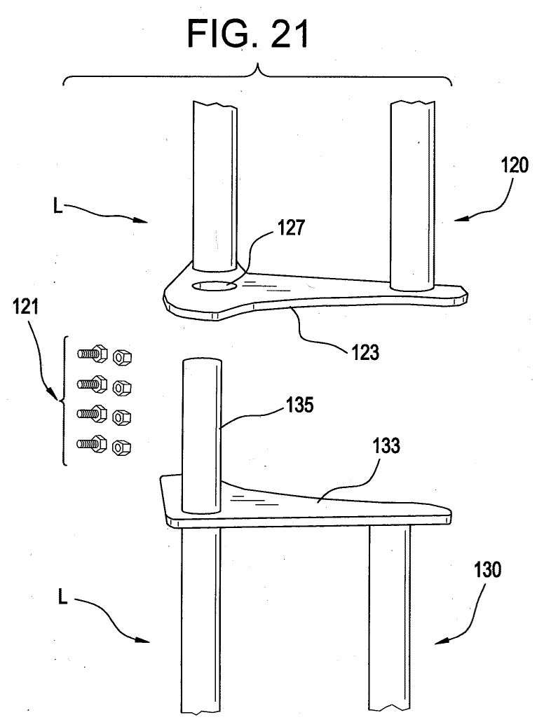

Reference is now made to FIGS. 18-20 which show the leveling mechanism that may be included at the ends of the support legs in each embodiment of the inventive stand. With reference, first, to FIG. 18, a leg L typical of the legs disclosed in earlier figures is shown with the leveling mechanism 110 adjacent thereto. FIG. 19 shows the leg L and the leveling mechanism 110 fastened to the bottom of the leg L. Fasteners 111 and 113 extend through holes in the leg L seen in FIG. 18 and designated by the reference numerals 106 and 108 and nuts fasten the fasteners 111 and 113 to the leg L. Reference numeral 121 in FIG. 21 shows bolts and nuts suitable for use as fasteners.

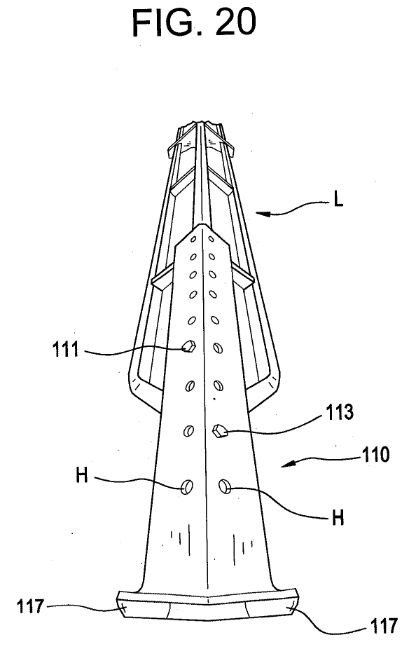

FIG. 20 in particular shows a plurality of holes H in the leveling mechanism 110 which facilitate aligning those holes with the holes 106 and 108 in the leg L at variable height between the leg L and the leveling mechanism 110 to facilitate extending or reducing the length of the leg L to level the leg L with respect to an uneven ground surface so that all legs employed in the inventive stand are equally engaging the ground surface to facilitate stable support of the stand. Tabs 117 (FIG. 20) can dig into the ground for additional stability.

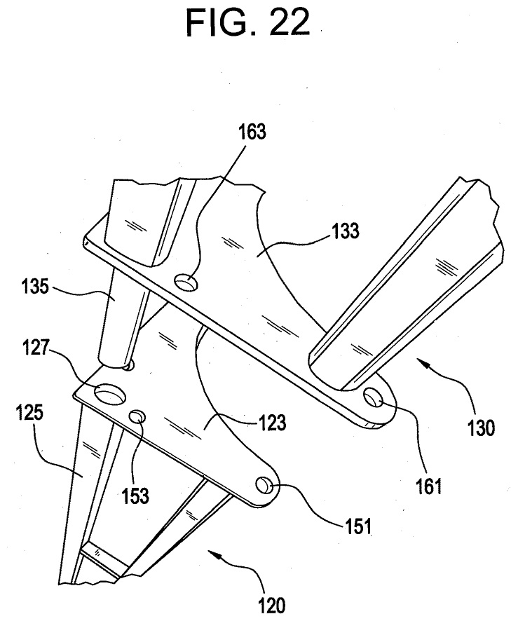

FIGS. 21-23 show a detail of the manner of interconnection of sections of a leg L. With reference first to FIG. 21, the leg L includes a section 120 and a section 130. A series of bolts and nuts are collectively designated by the reference numeral 121. As seen, the sections 120 and 130 have respective generally triangular plates 123 and 133 which when assembled abut one another. As more clearly shown in FIG. 22, in the preferred embodiment, each plate 123, 133 includes perpendicular straight sides connected by an arcuate side. The section 120 has a hollow rod 125 with a passageway therethrough which opens at 127. The section 130 includes a post 135 sized to enter the passageway opening 127 when the sections 120 and 130 are connected together. FIG. 22 shows the sections 120 and 130 as well as holes 151 and 153 in the plate 123 and aligned holes 161 and 163 in the plate 133. When the rod 135 enters the opening 127 in the hollow rod 125, the holes 151 and 161 are aligned as are the holes 153 and 163 and other respective holes in the plates 123 and 133. Once this occurs, the fasteners referred to by reference numeral 121 may be utilized to bolt the sections 120 and 130 together.

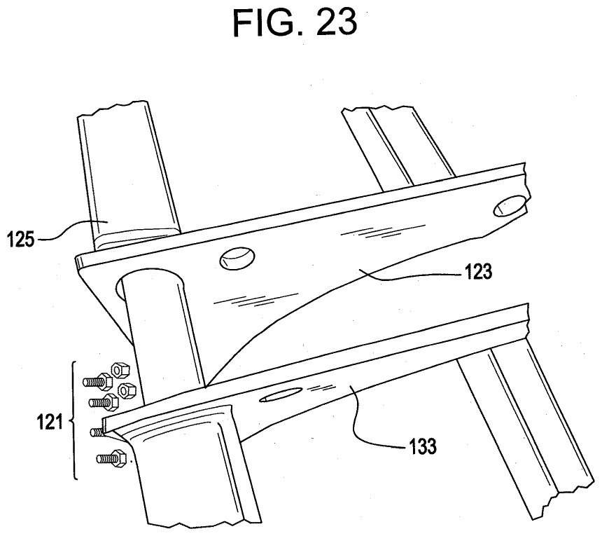

The same manner of interconnection is employed regardless of the number of sections to be connected together in order to elevate the platform 10 to its desired elevation. In one embodiment, three sections are employed for each leg L. Of course, one or two sections or more than three sections may suitably be employed. FIG. 23 shows the rod 135 entering the opening 127 in the hollow rod 125.

In the preferred embodiments, the inventive stand may be made of any suitable materials that provide rigidity and safety to a person sitting on the seat rotatably mounted on the platform 10. Materials such as various grades of steel or aluminum are preferred. Of course, wood materials may also be employed as desired.

The present invention adds versatility and provides a stand which is multi-purpose in its conception and in its operation. It may be used alternatively as a tree stand solely supported in an elevated fashion by a ladder and leaning against a pole or tree. It may have two or four legs to support it in a freestanding manner. The leveling mechanisms incorporated into the platform 10 allow the platform to be level so that a person can sit in the seat 45 mounted on the platform 10 in a safe manner.

The versatility and modular nature of the present invention give it significant advantages over prior art stands.

As such, an invention has been disclosed in terms of preferred embodiments thereof, which fulfill each and every one of the objects of the invention as set forth hereinabove, and provide a new and useful multi-purpose stand of great novelty and utility.

Of course, various changes, modifications, and alterations in the teachings of the present invention may be contemplated by those skilled in the art without departing from the intended spirit and scope thereof.

As such, it is intended that the present invention only be limited by the terms of the appended claims.

1. A platform for use in a stand comprising:
a) a substantially flat area having a periphery;
b) a first bracket on said flat area which includes a bearing for receiving a post supporting a seat;
c) a plate attached to said platform at said periphery and including a plurality of outwardly extending teeth;
d) opposite said plate, a second bracket attached to said platform and configured to couple with a ladder; and
e) third and fourth brackets attached to said platform at opposed sides of said plate, said third and fourth brackets configured to couple with support legs to elevate said platform.

2. The platform of claim 1, wherein said teeth are located in an arcuate configuration.

3. The platform of claim 1, wherein said second bracket comprises two spaced bracket members.

4. The platform of claim 1, wherein a ladder is attached to said second bracket.

5. The platform of claim 4, wherein fifth and sixth brackets are on said platform.

6. The platform of claim 3, wherein fifth and sixth brackets are on said platform.

7. The platform of claim 6, wherein said fifth bracket is located adjacent one of said two bracket members and said sixth bracket is located adjacent another of said two bracket members.

8. The platform of claim 4, wherein a first leg is attached to said third bracket and a second leg is attached to said fourth bracket.

9. The platform of claim 8, wherein said legs are each made of multiple leg sections attached together.

10. The platform of claim 9, wherein a third leg is attached to said fifth bracket and a fourth leg is attached to said sixth bracket.

11. The platform of claim 1, further including a level indicator.

12. The platform of claim 11, wherein said level indicator comprises two bubble levels mounted orthogonally on said platform.

13. The platform of claim 10, wherein said legs are each made of multiple leg sections attached together.

14. The platform of claim 1, wherein said post has a circular cross-section.

15. The platform of claim 14, wherein said bearing has a circular cross-section opening for receiving said post.

16. The platform of claim 1, wherein said flat area of said platform is made of a mesh material.

17. A platform for use in a stand comprising:
a) a substantially flat mesh area having a periphery;
b) a first bracket on said flat area which includes a bearing for receiving a post supporting a seat;
c) a plate attached to said platform at said periphery and including a plurality of outwardly extending teeth located in an arcuate configuration;
d) opposite said plate, a second bracket comprising two spaced bracket members and attached to said platform and configured to couple with a ladder; and
e) third and fourth brackets attached to said platform at opposed sides of said plate, said third and fourth brackets configured to couple with support legs to elevate said platform.

18. The platform of claim 17, wherein a ladder is attached to said second bracket.

19. The platform of claim 17, where fifth and sixth brackets are on said platform, said fifth bracket being located adjacent one of said two bracket members and said sixth bracket being located adjacent another of said two bracket members, a first leg being attached to said third bracket and a second leg being attached to said fourth bracket.

20. The platform of claim 17, further including a level indicator comprising two bubble levels mounted orthogonally on said platform.
